(19) United States
(12) Patent Application Publication
(10) Pub. No.: US 2018/0196922 A1
(43) Pub. Date: Jul. 12, 2018

(54) PROVIDING CONTEXT TO A PERSON'S HEALTH-RELATED TIME SERIES DATA

(71) Applicant: INTERNATIONAL BUSINESS MACHINES CORPORATION, Armonk, NY (US)

(72) Inventors: Tamer E. Abuelsaad, Somers, NY (US); Muhammed F. Bulut, Yorktown Heights, NY (US); Tolga Oral, West Roxbury, MA (US)

(21) Appl. No.: 15/405,160

(22) Filed: Jan. 12, 2017

(51) Int. Cl. G06F 19/00; G06Q 50/00

(52) U.S. Cl. CPC G06F 19/322; G06Q 50/01; G06F 19/328

(57) ABSTRACT

A computer system, method, and computer readable product are provided for providing a context to a person's health-related time series data. In various embodiments, a computing system determines a health data about a person from an Internet of Things (IoT) sensor device. The computing system determines whether there is an abnormality of the health data relative to a baseline data about the person's health. In response to determining that there is an abnormality, the system uses a rules engine or cognitive system to determine a context present when the first health data was present for the first person. Then, the system securely stores an association between the context and the first health data in a computer memory.

### BACKGROUND

### Technical Field

The present disclosure generally relates to sensors, and more particularly, to Internet of Things devices that measure human activity.

### Description of the Related Art

Internet of things (IoT) sensors and devices are generally communications-networked physical objects that may be embedded with electronics, software, sensors, and network connectivity. IoT devices are generally able to gather information from the physical world and share this information across a communications network. As applied to people, there are IoT devices that may measure, for example, information relating to heart rate, blood pressure, and the number of steps a person takes in a given time period.

### SUMMARY

In various embodiments, a computing system that implements an embodiment of the present disclosure determines a health data about a person from an Internet of Things (IoT) sensor device. The computing system determines that there is an abnormality of the health data relative to a baseline data about the person's health.

In response to determining that there is an abnormality, the system uses a rules engine or cognitive system to determine a context present when the first health data was present for the first person. Then, the system securely stores an association between the context and the first health data in a computer memory.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates examples of hardware used according to some embodiments of the present disclosure.

FIG. 2 illustrates an example of a system architecture used according to some embodiments of the present disclosure.

FIG. 3 illustrates an example process for providing context to a person's health-related time series data.

FIG. 4 illustrates an example process for identifying a context that corresponds to a person's health-related time series data.

FIG. 5 illustrates an example process for extracting a context for a person's health-related time series data from a financial transaction.

FIG. 6 illustrates an example process for identifying repeated anomalies in a person's health-related time series data.

### DETAILED DESCRIPTION

Detailed embodiments of the claimed structures and methods are disclosed herein. However, it may be understood that the disclosed embodiments are merely illustrative of the claimed structures and methods that may be embodied in various forms. The present disclosure may, however, be embodied in many different forms and should not be construed as limited to the example embodiments set forth herein. Rather, these example embodiments are provided so that this disclosure will be thorough and complete and will fully convey the scope of the present disclosure to those skilled in the art. In the description, details of well-known features and techniques may be omitted to avoid unnecessarily obscuring the presented embodiments.

As the following examples and embodiments are described, it may be appreciated how privacy can be implemented to ensure that a person's health data is kept secure. For example, the present disclosure may implement privacy of a person's health data that is compliant with HIPAA (Health Insurance Portability and Accountability Act), as well as other relevant laws. For example, a system that implements aspects of the present disclosure may anonymize a person's health data before propagating it; may share a change in patterns of health data rather than the raw data or an identity of a person associated with the data, and may store health data in a secure fashion. Additionally, each person may opt in to having his or her data used in each of the manners described herein.

Examples of IoT devices are a Fitbit® wearable fitness tracker that can measure aspects of a person's physical activity and sleep patterns, as well as IoT jewelry in the form of necklaces, earrings, bracelets, and watches. These IoT devices can collect various health data, such as hormone levels, glucose levels, heart rate, sleep patterns, breathing patterns, stress levels, body temperature, stress levels, and food and caloric intake. This health data may be referred to as health-related time series data, because it may be measured over a period of time, rather than a single time.

This health data can be collected over a period of time, and then examined during an annual checkup with a physician, as well as during other appointments with health care professionals. When a physician looks at this data, it may be difficult for him or her to understand why various changes in the health data have occurred over time, when these changes may be related to external events in the patient's life, or health-related issues for the patient. The present disclosure provides context to a patient's health information, so that a physician may better understand what that health information means.

A person may be using one or more IoT devices to capture one or more types of health information, and this captured health information may then be stored securely by a system that implements aspects of the present disclosure. The system may also determine whether other individuals are experiencing similar circumstances as the person, which may be done by determining a physical proximity between two people's respective IoT devices. For example, the proximity may be determined by the devices' GPS (Global Positioning System), or by the devices that are configured to determine whether they are in close proximity—such as by using an (NFC) near field communications protocol, or a BLUETOOTH protocol. Social network activity may also be used to determine proximity—such as where two people check into the same location at a similar time on one or more social networks. These similar circumstances may include, without limitation, co-workers eating a meal together, friends going out and dancing, and/or people jogging together. Then, the system may provide context and trends for the health data, without sharing the actual health data of the involved people.

More specific examples of similar circumstances are as follows. A person may be eating lunch with coworkers, and as a result of eating food, the glucose levels of all diners may rise at approximately the same time. A person and his or her significant other may be watching a movie at a movie theater (which can be established by associating a GPS location with the movie theater, for example), and during an exciting part of the movie, both people's heart rate may increase. A person and some of his or her colleagues may be having a client meeting, and everyone's stress levels are higher when meeting with this particular client.

Contextual data about gathered health data may be used to annotate that health data. Then, the insight from annotating health data with contextual data may help a physician or other health care professional understand what may be ignored in health data abnormalities, such as glucose or heart rate spikes that correspond to similar spikes of people that the patient was with at the time of the spikes.

In some embodiments, the system may also cluster anomalies that are similar and relate them with corresponding contexts so that a physician can see patterns more easily. For example, an anomaly of a heart rate or glucose level spike may be clustered on the same time on Sunday. The anomaly may be clustered on a person spending time with the same friend. The anomaly may be clustered on the person eating the same thing or being in the same physical location.

A system that implements some embodiments may capture a stream of health-related time series data from one or more IoT devices for one or more people, including data such as hormone levels, glucose levels, vital signs, heart rate, body temperature, sleep and wake patterns, activity (such as steps taken or a speed traveled at), stress levels, breathing patterns, and caloric intake, and store this data in a data store. The system may also capture contextual data to accompany the health data. Contextual data may include a geolocation from a smartphone, a credit card transaction (e.g., that indicates that the person purchased something from a vegetarian restaurant), a digital payment (e.g., an APPLE PAY digital payment, which may indicate purchasing a ticket to a particular movie, and where the movie metadata may be extracted from a movie database such as the IMDB movie database, and classified as to whether it is scary), and context from social feeds (e.g., to derive a physical location of the person, people who are present with the person, the person's activity, or the person's mood). The person may opt in to sharing each of these forms of contextual data with the system.

This gathered health data and contextual data may be associated together using a respective timestamp on each data that indicates that the two forms of data were generated at a similar time. Then, a subsystem of the system, which comprises a rules engine or a cognitive system such as a Watson Health™ cognitive system, may be used to combine time slices of health data and contextual data with a person's electronic medical record (EMR). This subsystem may combine all given time slices with a person's EMR, or select time slices. These select time slices may include events that are logged for all people, like excessive sweating combined with low heart rate, or a dangerous increase in heart rate. These time slices may also include events that are specific to a person's particular health situation, such as glucose and insulin levels for a diabetic patient.

Other examples of health-data-and-contextual-data time slices that may be combined with a person's EMR include matching a person's heartbeat patterns to known abnormal patterns for a heart episode or heart murmur, a spike in stress hormones, or elevated sodium levels and troubled breathing patterns for a person with a known congestive heart failure risk.

Another subsystem of the system—a Health Data Insight subsystem—may receive input as these time slices described above. This subsystem may then examine and correlate the contextual data for the same time period or time slice. For example, a spike in someone's stress hormones and heart rate may have occurred after he or she purchased tickets to a movie that is classified as scary or high intensity. In addition, a second person may have also been present and a substantially similar pattern in his or her health data may be observed. This Health Data Insight subsystem may confirm and associate a person's health data with that of other people while also providing anonymity for each person involved. In this example, the Health Data Insight subsystem may notice similar changes in two people's health data, where these two people are friends on a social network, and checked-in at the same horror movie. The Health Data Insight subsystem may provide this contextual information and use it to annotate both persons' health data, while keeping their respective identity concealed. This insight may then be provided to a health care professional, such as by storing it in a person's EMR—for example, during a doctor visits for a specific ailment, an emergency room visit, or an annual checkup.

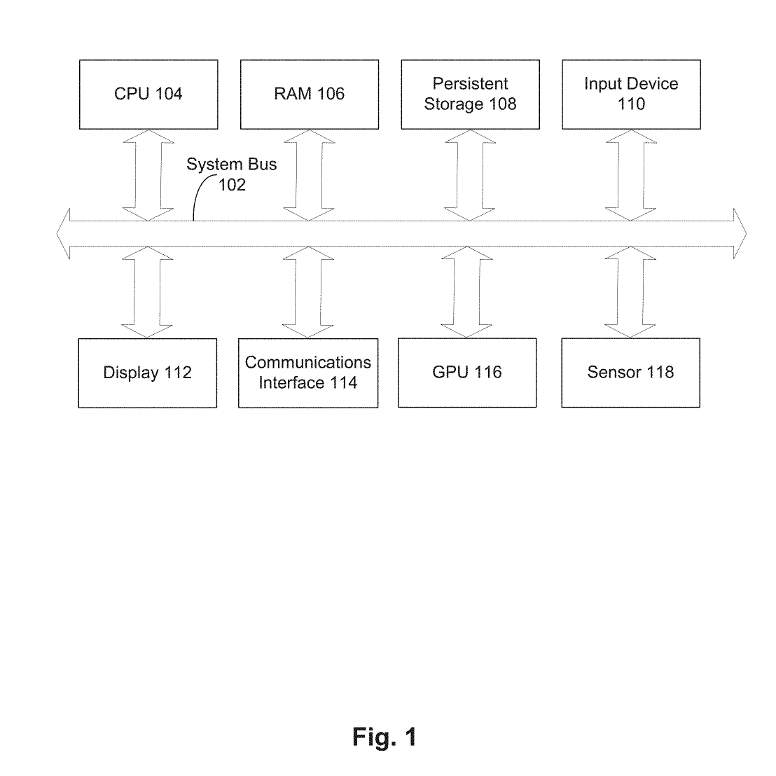

FIG. 1 illustrates an example of hardware used according to an embodiment of the present disclosure. As shown in FIG. 1, a block diagram illustrates various computer hardware that may be used for providing context to a person's health-related time series data, consistent with an exemplary embodiment. In some embodiments, the computer hardware of FIG. 1 may be embodied in an IoT device.

The CPU (central processing unit) 104, RAM (random access memory) 106, persistent storage 108, input device 110, display 112, communications interface 114, GPU (graphics processing unit) 116, and sensor 118 are connected to a system bus 102. It may be appreciated that the system bus 102 is presented logically and simplified, and that two or more of these components may be communicatively coupled by one or more separate buses. It also may be appreciated that the depictions of CPU 104 and GPU 116 are simplified to emphasize the components that are depicted—for example they omit hardware that controls the flow of computer-executable instructions within them.

In FIG. 1, the persistent storage 108, in one embodiment, has capabilities that include storing a program that can execute the processes described herein. Persistent storage 108, in an embodiment of the present disclosure, can store an executing application that effectuates providing context to a person's health-related time series data. Additionally, in FIG. 1, an input device 110, such as a keyboard and a mouse may be used to provide input to the computer hardware of FIG. 1.

In one embodiment, the communications interface 114 of FIG. 1 is connected to a communications network using a Wi-Fi (wireless-fidelity) or LTE (long-term evolution) network communications protocol. Communications interface 114 may also comprise a NIC (network interface card) that is connected to a communications network via an Ethernet cable. In the present disclosure, communications interface 114 may be used to transmit information about a person's health-related time series data to one or more other computers, which may include a central computer that stores this time series data and determines accompanying contextual data for that time series data. These external computers may be accessible via a communications network.

Communications interface 114 may receive processing requests in accordance with a communication protocol, such as TCP/IP (Transmission Control Protocol/Internet Protocol), from another computer (not shown), and processing results are sent to a third computer (not shown). As depicted, communications interface 114 may comprise hardware for transmitting and receiving network data, and/or processor-executable instructions for doing the same.

Sensor 118 may be one of a variety of sensors that is configured to capture health data from a person. Sensor 118 may be a sensor that captures a person's hormone levels, glucose levels, heart rate, sleep patterns, breathing patterns, stress levels, body temperature, stress levels, or food and caloric intake.

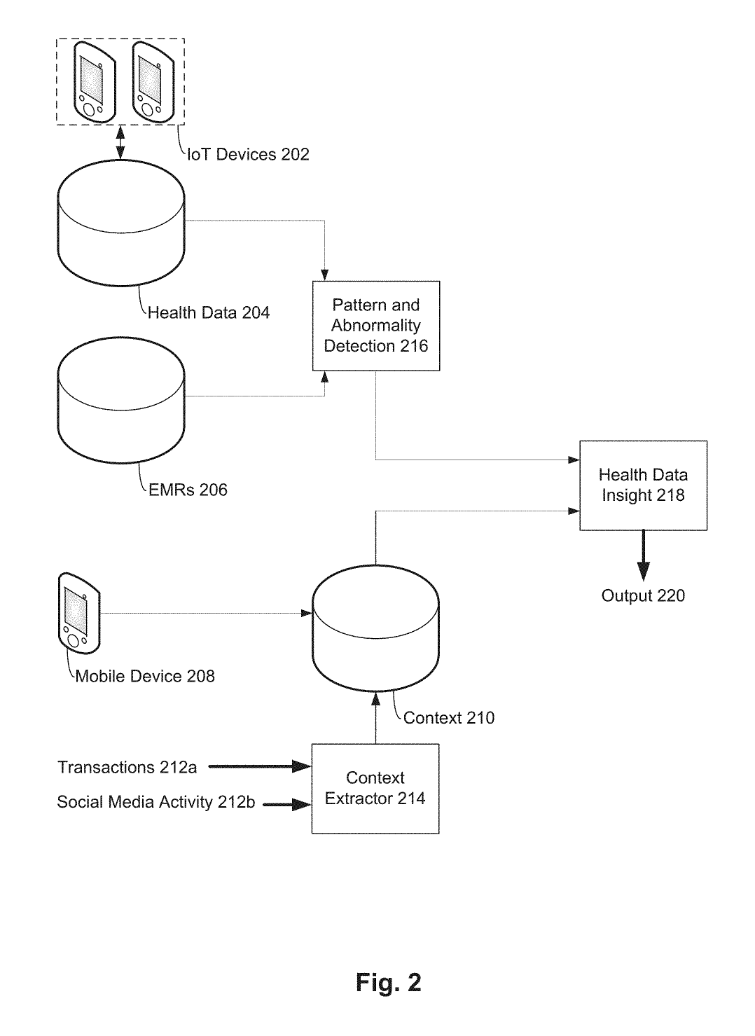

FIG. 2 illustrates an example of a system architecture used according to some embodiments of the present disclosure. For example, each of the IoT (Internet of Things) devices 202, health data 204, EMRs (electronic medical records) 206, mobile device 208, context 210, context extractor module 214, pattern and abnormality detection module 216, and health data insight module 218, may be implemented in an instance of the computer hardware of FIG. 1. Two or more of these components may be implemented in the same instance of the computer hardware of FIG. 1. Health data 204, EMRs 206, and context 210 are depicted here as data stores, and when implemented in instances of the computer hardware of FIG. 1, may be implemented in RAM 106 or persistent storage 108.

As depicted, there are three types of inputs to the system architecture of FIG. 2. A first type of input to the system architecture comes from IoT devices 202. These inputs may provide health data for a person, such as a heart rate, a hormone level, a glucose level, a sleep pattern, a breathing pattern, a stress level, a body temperature, or a food or caloric intake by the person.

A second type of input to the system architecture comprises information for which context is extracted, such as transactions 212a and social media activity 212b. Transactions 212a may be financial, like credit card transactions, from which context information may be extracted, like a place the person was physically located at or an activity the person was engaged in (e.g., the financial transaction information may indicate that the person purchased a movie ticket). Social media activity 212b may be postings by a person to social media, or postings by another person that indicate the person's activity—such as a location where the person is or a second person the person is with. This information for which context is extracted may be extracted by the context extractor module 214.

A third type of input to the system architecture comprises context information that may be accessed directly without extraction. For example, mobile device 208 may be configured to determine GPS information for the person who owns the device. As depicted, since this information is not extracted in a manner similar to how context is extracted from financial transaction information, mobile device 208 provides input directly to context 210 instead of first passing through context extractor module 214.

Health data 204 and EMRs 206 serve as inputs to pattern and abnormality detection module 216. Information from a person's EMRs may serve as a baseline for that person's health data (e.g., it may indicate what a person's heart rate or blood pressure has typically been). Then, health data 204 may be more recent data. Where the health data 204 deviates from the baseline data (e.g., the person's heart rate or blood pressure, as indicated in health data 204, diverges from the baseline data by more than a predetermined threshold amount), that may be considered to be an anomaly in the person's health data that is identified by pattern and abnormality detection module 216.

Once an abnormality has been identified (by pattern and abnormality detection module 216) and context has also been identified (and stored in context 210), the abnormality and context serve as inputs to health data insight module 218. Health data insight module 218 analyzes the abnormality and the context to find information in the context data that may be casually connected to the abnormality.

For example, a person's blood pressure may spike every time he or she eats at a certain restaurant, regardless of which people he or she eats with, or a time of day, week, or month at which he or she eats. Given this input, health data insight module 218 may determine an insight that the context information relating to where the person eats may be casually connected to the spiked heart rate, where the information about who the person eats with and when the person eats, may be irrelevant. To determine this insight, health data insight module 218 may be implemented with a rules engine or a cognitive system such as a Watson Health™ cognitive system. It may be appreciated that this example using three types of context (i.e., location, company, and time) is simplified, and that health data insight module 218 may determine an insight using much more complicated data sets—more complicated both in terms of abnormalities in the data sets (which may appear only sometimes given a certain context) and context in the data sets.

Where health data insight module 218 identifies an insight, health data insight module 218 may produce this insight as output 220. Output 220 may then be stored in a location (such as the person's EMRs 206, though an arrow from output 220 to EMRs 206 is not depicted in FIG. 2), where a health care professional may access it, and use the information in caring for and treating the person.

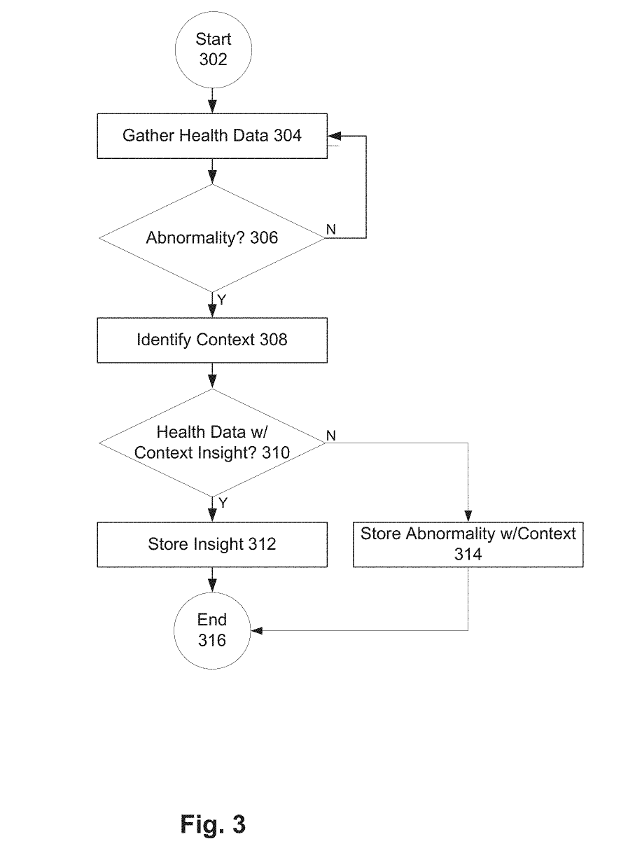

FIG. 3 illustrates an example process for providing context to a person's health-related time series data. In some embodiments, the process of FIG. 3 may be implemented on the computer hardware of FIG. 1 or the system architecture of FIG. 2 to effectuate providing context to a person's health-related time series data. In some embodiments, the process of FIG. 3 may be implemented to effectuate a computer-implemented method for providing context to a first person's health data, or a computer system for providing context to a first person's health data.

It may be appreciated that the process of FIG. 3 is an example process, and that there may be embodiments that implement more or fewer operations than are disclosed. It may also be appreciated that there may be embodiments that implement the operations of FIG. 3 in a different order than they are depicted in FIG. 3.

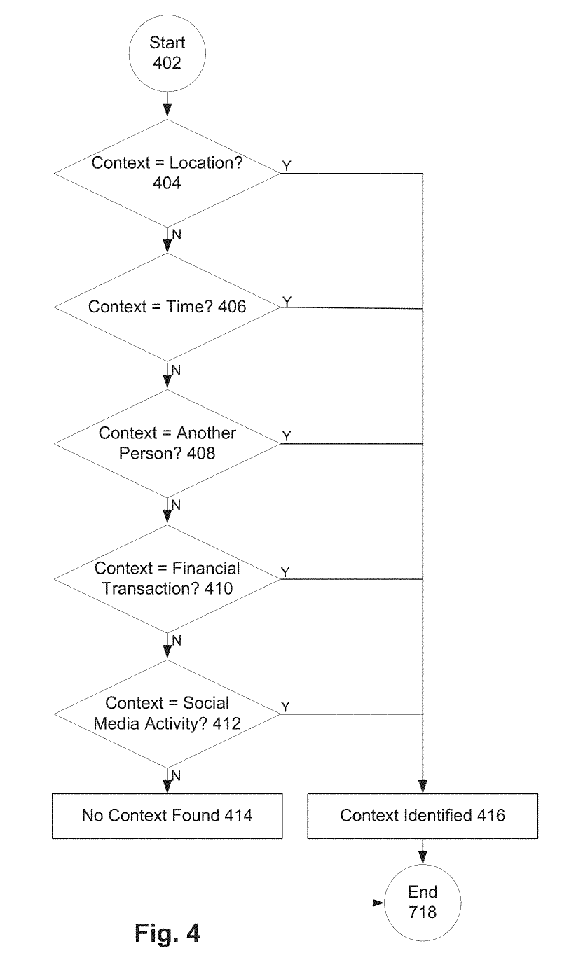

It may further be appreciated that the operations of FIG. 3 may be implemented in conjunction with the operations of other figures. For example, the process of FIG. 3 may be implemented in conjunction with the process of FIG. 4, which may be implemented in order to determine a context for a user's health data from a plurality of context sources.

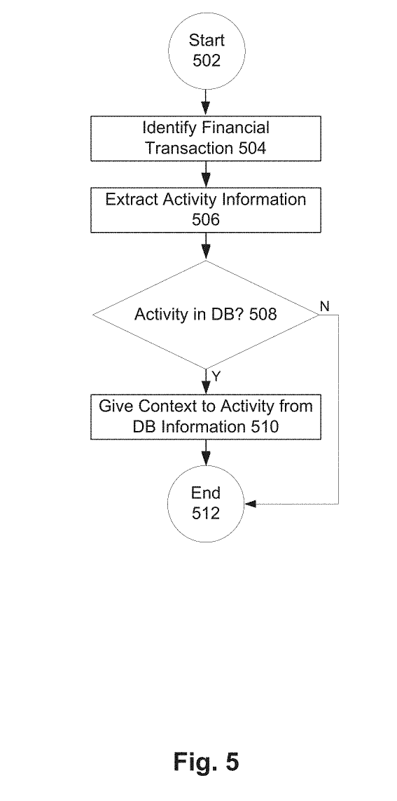

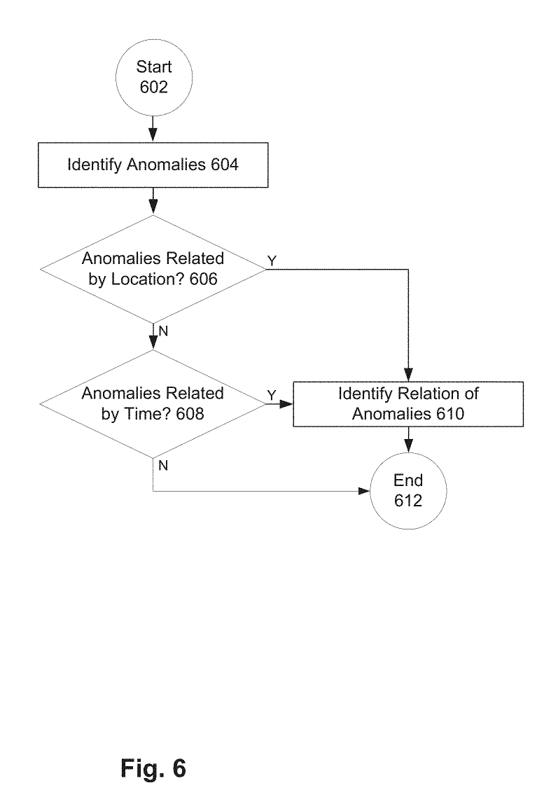

By way of another example, the operations of FIG. 3 may be implemented in conjunction with the operations of FIG. 5, which may be implemented in order to extract context information from a user's financial transaction. The operations of FIG. 3 may also be implemented in conjunction with the operations of FIG. 6, which may be implemented in order to identify repeated, possibly-related anomalies in a user's health data.

The process of FIG. 3 begins with operation 302 and moves to operation 304. Operation 304 depicts gathering health data. Gathering health data may comprise receiving health data from an IoT device that a user uses, such as a phone that measures the distance the user walks, or the user's heart rate, or a watch that performs similar functions.

In some embodiments, the first health data about the first person comprises a heart rate, a hormone level, a glucose level, a sleep pattern, a breathing pattern, a stress level, a body temperature, or a food or caloric intake by the person. In some embodiments, operation 304 may comprise determining a first health data about the first person from an Internet of Things (IoT) sensor device. After operation 304, the process of FIG. 3 moves to operation 306.

Operation 306 depicts determining whether there is an abnormality in the health data. There may be a baseline health data for a person, and a deviation from this baseline data that is above a predetermined threshold may be considered to be an abnormality. For example, if a person's heart rate while asleep is typically around 60 beats per minute, based on the person's baseline data, and it is measured at 90 beats per minute, this may be determined to be an abnormality in operation 306. A person's electronic medical record (EMR) may be used to determine baseline health data.

In some embodiments, operation 306 comprises determining that there is an abnormality of the first health data relative to a baseline data about the first person's health. In some embodiments, operation 306 comprises determining the baseline data about the person's health from an EMR for the person.

Upon determining that there is an abnormality in the health data, the process of FIG. 3 moves to operation 308. Instead, upon determining that there is not an abnormality in the health data, the process of FIG. 3 returns to operation 304. In this manner, where operations 304 and 306 loop, health data that is generated for a user may be monitored for abnormalities, and further operations (here, operations 308-316) may be performed when an abnormality is discovered.

Operation 308 is reached from operation 308 upon determining that there is an abnormality in the health data. Operation 308 depicts identifying a context for the health data. A context may provide information about why the abnormality occurred. A context may be, for example, a time, a physical location, a second person who the person is with, or an activity the person is partaking in.

In some embodiments, operation 308 comprises identifying the context based on a second person who was in a physical location proximal to the first person. In some embodiments, operation 308 comprises determining whether the second person was in a physical location proximal to the first person based on a global positioning system (GPS) information of a computing device of the second person and a GPS information of a computing device of the first person. In some embodiments, operation 308 comprises determining whether the second person was in a physical location proximal to the first person based on a short-range wireless communication between a computing device of the second person and a computing device of the first person. A short-range wireless communication may comprise communication according to a Bluetooth® protocol, a Nearfield Communication (NFC) protocol, a Digital Enhanced Cordless Telecommunications (DECT) protocol, or the like. After operation 308, the process of FIG. 3 moves to operation 310.

Operation 310 depicts determining whether there is an insight found between the health data and the context. This insight may comprise identifying a correlation between the abnormality in the health data and the context in which the abnormality occurs. For example, an insight may be that a person's insulin level rises above a predetermined threshold when the person goes to a particular restaurant and eats a particular meal. In other embodiments, the insight may comprise identifying an abnormality in the health data that is not explained by the context in which the abnormality occurs. More detail on insights between health data and the context are described with respect to the process of FIG. 4.

In some embodiments, operation 310 comprises, in response to determining that there is an abnormality, using a rules engine or cognitive system to determine a context present when the first health data was present for the first person. Upon determining in operation 310 that there is an insight found between the health data and the context, the process of FIG. 3 moves to operation 312. Instead, upon determining in operation 310 that there is no insight found between the health data and the context, the process of FIG. 3 moves to operation 314.

Operation 312 is reached from operation 310 upon determining that there is an insight found between the health data and the context. Operation 312 depicts storing an indication of the insight. This indication of the insight may be stored as an entry in the person's EMR, so that a health care professional who accesses the EMR in the course of treating the person may encounter it, and use that information in developing a treatment plan.

In some embodiments, operation 312 comprises securely storing an association between the context and the first health data in a computer memory. The association may be stored securely in that it is stored using encryption and/or other approaches to securing data that meet relevant standards for securing data about a person's health. In some embodiments, operation 312 comprises using and storing the first health data about the first person in accordance with a Health Insurance Portability and Accountability Act (HIPAA) standard. After operation 312, the process of FIG. 3 moves to operation 316, where the process of FIG. 3 ends.

Operation 314 is reached from operation 310 upon determining that there is not an insight found between the health data and the context. Operation 314 depicts storing an indication of the abnormality in the health data and the context. In some embodiments, operation 314 may be implemented in a similar manner as operation 312. After operation 314, the process of FIG. 3 moves to operation 316, where the process of FIG. 3 ends.

FIG. 4 illustrates an example process for identifying a context that corresponds to a person's health-related time series data. In some embodiments, the process of FIG. 4 may be implemented on the computer hardware of FIG. 1 or the system architecture of FIG. 2 to effectuate providing context to a person's health-related time series data.

It may be appreciated that the process of FIG. 4 is an example process, and that there may be embodiments that implement more or fewer operations than are disclosed. It may also be appreciated that there may be embodiments that implement the operations of FIG. 4 in a different order than they are depicted in FIG. 4. It may further be appreciated that the operations of FIG. 4 may be implemented in conjunction with the operations of other figures. While the example process of FIG. 4 involves a single context leading to an insight between the context and the abnormality, it may be appreciated that there may be embodiments where an insight is determined between a combination of contexts and a given abnormality.

The process of FIG. 4 begins with operation 402, and then moves to operation 404. Operation 404 depicts determining whether the insight is from a location-based context. A location-based context may be a physical location that a person was in when abnormal health data was generated. Where there is an insight derived from a location-based context, it may be determined that there is something the person does in the location that is related to the abnormality in the health data. For instance, the location may be work and the person may be stressed out at work, or the location may be a restaurant where the person frequently eats unhealthy meals.

In some embodiments, operation 404 comprises identifying the context based on a physical location at which the first health data about the person was measured from the person. Upon determining in operation 404 that the insight is from a location-based context, the process of FIG. 4 moves to operation 416. Instead, upon determining in operation 404 that the insight is not from a location-based context, the process of FIG. 4 moves to operation 406.

Operation 406 is reached from operation 404 upon determining that the insight is not from a location-based context. Operation 406 depicts determining whether the insight is from a time-based context. A time-based context may be a time of the day, week, month or other time period when the abnormal health data was generated. For example, a person's stress hormone levels may spike at 8:30 every weekday morning when he or she is commuting during rush hour traffic to work, or near the end of each month when bills are due but the person does not receive another paycheck until the first of the next month.

In some embodiments, operation 406 comprises identifying the context based on a time at which the first health data about the person was measured from the person. Upon determining in operation 406 that the insight is from a time-based context, the process of FIG. 4 moves to operation 416. Instead, upon determining in operation 406 that the insight is not from a time-based context, the process of FIG. 4 moves to operation 408.

Operation 408 is reached from operation 406 upon determining that the insight is not from a time-based context. Operation 408 depicts determining whether the insight is from a context of another person. A context of another person may be another person that a person was with when abnormal health data was generated. It may be that spending time with this other person generates the insight—a person may be more or less relaxed when spending time with a particular family member.

Or, there may be a secondary level of analysis—it may be that the person's activity may be known based on what is known about the activity of the other person. For example, it may be determined that the two people are together at a restaurant because of their respective location data of their IoT device. And then, it may be that the second person has a financial transaction that shows that he or she ordered two meals, so consuming one of those meals may be imputed to the person.

Where information for the second person is used in determining insights for a person's health information, steps may be taken to protect this second person's information (as well as the person's information). For example, it may be that this data is collected and used after the second person has affirmatively opted in to such use and collection. The second person's information may be anonymized, so that it is not tied to the second person himself or herself, but merely to some other person. Furthermore, the second person's information may be stored securely in a similar manner as to how the person's information is stored securely.

The use of other people's anonymized health data may be generally used to determine one of two outcomes. A first outcome for which other people's anonymized health data may be used is to detect that an anomaly in a person's health data is due to environmental factors. For example, the person's heart rate may have spiked because he or she was watching a thriller movie, and it may be determined that this environmental factor is a likely cause because other people's anonymized health data shows that those people who watched the same movie had similar heart rate spikes at similar times.

A second outcome for which other people's anonymized health data may be used is to detect that an anomaly in a person's health data is unique to that person. For example, it may be that a person shows a health anomaly that is not experienced by similarly-situated people (e.g., those in a similar location or doing a similar activity). In that case, it may be determined that the anomaly in the person's health data could be an actual health problem that should be evaluated by a medical professional.

In some embodiments, operation 408 comprises determining that the second person was in a physical location proximal to the first person based on a GPS location of a computing device of the second person and a GPS location of a computing device of the first person. In some embodiments, operation 408 comprises determining that the second person was in a physical location proximal to the first person based on a near field communication between a computing device of the second person and a computing device of the first person. In some embodiments, operation 408 comprises anonymizing information about a second person used in determining the context.

Upon determining in operation 408 that the insight is from a context of another person, the process of FIG. 4 moves to operation 416. Instead, upon determining in operation 408 that the insight is not from a context of another person, the process of FIG. 4 moves to operation 410.

Operation 410 is reached from operation 408 upon determining that the insight is not from a context of another person. Operation 410 depicts determining whether the insight is from a financial-transaction context. A financial-transaction context may be a financial transaction that a person conducted around the time when abnormal health data was generated. For example, financial transaction information may identify a location of the person (e.g., a restaurant or a movie theater), and what the person did at that location (e.g., purchased a particular meal, or purchased a ticket to a particular movie).

In some embodiments, operation 410 comprises identifying the context based on a credit card transaction associated with the first health data about the person. In some embodiments, operation 410 comprises extracting an activity of the first person associated with the first person from the credit card transaction. In some embodiments, operation 410 comprises identifying the context based on a digital payment associated with the first health data about the person.

Upon determining in operation 410 that the insight is from a financial-transaction context, the process of FIG. 4 moves to operation 416. Instead, upon determining in operation 410 that the insight is not from a financial-transaction context, the process of FIG. 4 moves to operation 412.

Operation 412 is reached from operation 410 upon determining that the insight is not from a financial-transaction context. Operation 412 depicts determining whether the insight is from a social-media-activity context. A social-media-activity context may be an activity that a person has made on a social media platform, such as checking in to a physical location, or indicating that the person is with a second person.

As with other information about the person and other people, social media activity may be used in making these determinations after a person has affirmatively opted in to the use of his or her social media activity in this manner. In some embodiments, operation 412 comprises identifying the context based on a social media activity of the first person.

Upon determining in operation 412 that the insight is from a social-media-activity context, the process of FIG. 4 moves to operation 416. Instead, upon determining in operation 412 that the insight is not from a social-media-activity context, the process of FIG. 4 moves to operation 414.

Operation 414 is reached from operation 412 upon determining that the insight is not from a social-media-activity context. Operation 414 depicts determining that no context is found. It may be that there is no context identified for when the abnormality occurred. It may also be that one or more contexts have been identified, but an insight has not been determined between this context or contexts and the abnormality. After operation 414, the process of FIG. 4 moves to operation 418, where the process of FIG. 4 ends.

Operation 416 is reached from operations 404-412 under certain conditions. For example, operation 416 is reached upon determining in operation 404 that the insight is from a location-based context; upon determining in operation 406 that the insight is from a time-based context; upon determining in operation 408 that the insight is from a context of another person; upon determining in operation 410 that the insight is from a financial-transaction context; or upon determining in operation 412 that the insight is from a social-media-activity context.

Operation 416 depicts determining that the context has been identified. Identifying the context may comprise determining an insight between the context and the abnormality—that there is likely to be a causal relationship between the two. Where this context is identified, an indication of this insight between the context and the abnormality may be stored, such as in the person's EMR. After operation 416, the process of FIG. 4 moves to operation 418, where the process of FIG. 4 ends.

FIG. 5 illustrates an example process for extracting a context for a person's health-related time series data from a financial transaction. In some embodiments, the process of FIG. 5 may be implemented on the computer hardware of FIG. 1 and/or the system architecture of FIG. 2 to effectuate providing context to a person's health-related time series data.

It may be appreciated that the process of FIG. 5 is an example process, and that there may be embodiments that implement more or fewer operations than are disclosed. It may also be appreciated that there may be embodiments that implement the operations of FIG. 5 in a different order than they are depicted in FIG. 5. It may further be appreciated that the operations of FIG. 5 may be implemented in conjunction with the operations of other processes discussed herein.

The process of FIG. 5 begins with operation 502 and moves to operation 504. Operation 504 depicts identifying a financial transaction. A financial transaction may comprise a credit card transaction or a digital transaction (such as via a Apple Pay® or Samsung Pay® digital transaction platform). Identifying a financial transaction may comprise identifying a transaction that occurred at a time similar to when abnormal health data is generated for a person. After operation 504, the process of FIG. 5 moves to operation 506.

Operation 506 depicts extracting activity information from the financial transaction. A financial transaction may include several types of information—a time at which the financial transaction occurred, a physical place where the financial transaction occurred, a business associated with the financial transaction, and information about the specific activity (e.g., a particular meal, or movie, concert, or airline ticket purchased). This information may be extracted through processing the financial transaction information. For example, where the financial transaction is represented via text, text processing may be performed to extract this activity information. After operation 506, the process of FIG. 5 moves to operation 508.

Operation 508 depicts determining whether the activity information is found in a database. This database (or these databases) may store information about a particular activity. For example, a database of movies may store information about which ones are scary, or otherwise tend to elicit strong emotional responses in a viewer. A database of food may store information about the nutritional content of various meals. Determining whether the activity information is found in a database may comprise querying a database with the activity information.

Upon determining in operation 508 that the activity information is found in a database, the process of FIG. 5 moves to operation 510. Instead, upon determining in operation 508 that the activity information is found not in a database, the process of FIG. 5 moves to operation 512, where the process of FIG. 5 ends.

Operation 510 is reached from operation 508 upon determining, in operation 508, that the activity information is found in a database. Operation 510 depicts giving context to the activity from the database information. Continuing with the examples of operation 508, this context to the activity may include whether a particular movie is scary, or the nutritional information for a particular meal. After operation 510, the process of FIG. 5 moves to operation 512, where the process of FIG. 5 ends.

FIG. 6 illustrates an example process for identifying repeated anomalies in a person's health-related time series data. In some embodiments, the process of FIG. 6 may be implemented on the computer hardware of FIG. 1 and/or the system architecture of FIG. 2 to effectuate providing context to a person's health-related time series data.

It may be appreciated that the process of FIG. 6 is an example process, and that there may be embodiments that implement more or fewer operations than are disclosed. It may also be appreciated that there may be embodiments that implement the operations of FIG. 6 in a different order than they are depicted in FIG. 6. It may further be appreciated that the operations of FIG. 6 may be implemented in conjunction with the operations of other figures. While the process of FIG. 6 depicts that anomalies may be related by physical location or by time, it may be appreciated that there may be permutations. It may be that the anomalies occur at a particular combination of time and location, or using one or more other contexts.

The process of FIG. 6 begins with operation 602, and then moves to operation 604. Operation 604 depicts identifying anomalies. These may be abnormalities for a person in that person's health data, such as described with respect to the process of FIG. 3.

In some embodiments, the abnormality is a type of abnormality that may be present for all people. An example of an abnormality that may be observed for people is an elevated heart rate. In some embodiments, the abnormality may be present for the first person but not for a second person. An example of a type of abnormality that may be present for some people but not all people may be a particular insulin level for diabetics (where such an insulin level is not considered to be abnormal for non-diabetic people).

After operation 604, the process of FIG. 6 moves to operation 606. Operation 606 depicts determining whether the anomalies are related by location. Using physical location as a context is described with respect to the processes of FIGS. 3-4, and it may be that repeated health anomalies for a person are found when a person is at a particular physical location.

In some embodiments, operation 606 comprises determining that the anomaly occurs repeatedly when the first person is at a physical location. Upon determining in operation 606 that the anomalies are related by location, the process of FIG. 6 moves to operation 610. Instead, upon determining in operation 606 that the anomalies are not related by location, the process of FIG. 6 moves to operation 608.

Operation 608 is reached from operation 606 upon determining that the anomalies are not related by location. Operation 608 depicts determining whether the anomalies are related by time. Similar to operation 606 as applied to location, repeated anomalies may be found that correspond to a particular time. This may be a time of day (the morning), week (Monday), month (the first of the month), or year (an annual holiday where families traditionally gather).

In some embodiments, operation 608 comprises determining that the anomaly occurs repeatedly at a particular time of day, week, or month. Upon determining in operation 608 that the anomalies are related by time, the process of FIG. 6 moves to operation 610. Instead, upon determining in operation 608 that the anomalies are not related by time, the process of FIG. 6 moves to operation 612, where the process of FIG. 6 ends.

Operation 610 is reached from operation 606 upon determining that the anomalies are related by location, or from operation 608 upon determining that the anomalies are related by time. Operation 610 depicts identifying a relation between the anomalies. Identifying a relation between the anomalies may comprise storing an indication of such in the person's EMR, such as that the person generally has an elevated heart rate on Monday mornings. After operation 610, the process of FIG. 6 moves to operation 612, where the process of FIG. 6 ends.

### CONCLUSION

Detailed embodiments of the claimed structures and methods are disclosed herein. However, it can be understood that the disclosed embodiments are merely illustrative of the claimed structures and methods that may be embodied in various forms. The present disclosure may, however, be embodied in many different forms and should not be construed as limited to the example embodiments set forth herein. Rather, these example embodiments are provided so that this disclosure will be thorough and complete and will fully convey the scope of the present disclosure to those skilled in the art. In the description, details of well-known features and techniques may be omitted to avoid unnecessarily obscuring the presented embodiments.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible and/or non-transitory device that may retain and store instructions for use by an instruction execution device. For example, the computer readable storage medium may be, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD, alternatively known as a digital video disc), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as a Smalltalk or C++ programming language or the like, and conventional procedural programming languages, such as a C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an (ISP) Internet Service Provider). In some embodiments, electronic circuitry including, for example, programmable logic circuitry, field-programmable gate arrays (FPGA), or programmable logic arrays (PLA), may execute the computer readable program instructions by utilizing state information of the computer readable program instructions to personalize the electronic circuitry, in order to perform aspects of the present disclosure.

Aspects of the present disclosure are described herein with reference to process or flowchart illustrations, and/or block diagrams of methods, apparatus (systems), and computer program products according to some embodiments of the present disclosure, and these illustrations may comprise one or more operations. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for providing context to a first person's health data, the method comprising:
determining a first health data about the first person from an Internet of Things (IoT) sensor device;
determining that there is an abnormality of the first health data relative to a baseline data about the first person's health;
in response to determining that there is an abnormality, using a rules engine or cognitive system to determine a context present when the first health data was present for the first person; and
securely storing an association between the context and the first health data in a computer memory.

2. The computer-implemented method of claim 1, further comprising:
using and storing the first health data about the first person in accordance with a Health Insurance Portability and Accountability Act (HIPAA) standard.

3. The computer-implemented method of claim 1, further comprising:
determining the baseline data about the person's health from an electronic medical record (EMR) for the person.

4. The computer-implemented method of claim 1, wherein the first health data about the first person comprises at least one of: (i) a heart rate, (ii) a hormone level, (iii) a glucose level, (iv) a sleep pattern, (v) a breathing pattern, (vi) a stress level, (vii) a body temperature, and (viii) a food or caloric intake by the person.

5. The computer-implemented method of claim 1, further comprising:
identifying the context based on a second person who was within a predetermined physical distance of the first person at a given time.

6. The computer implemented method of claim 5, further comprising:
determining whether the second person was in a physical location proximal to the first person based on a global positioning system (GPS) information of a computing device of the second person and a GPS information of a computing device of the first person.

7. The computer implemented method of claim 5, further comprising:
determining whether the second person was in a physical location proximal to the first person based on a short-range wireless communication between a computing device of the second person and a computing device of the first person.

8. A computer system configured to provide context to a first person's health data, comprising:
a processor, a computer-readable memory, a computer-readable tangible storage device, and program instructions stored on the storage device for execution by the processor via the memory, wherein execution of the program instructions by the computer system configures the computer system to:
determine a first health data about the first person;
determine whether there is an abnormality of the first health data relative to a baseline data about the person's health;
in response to determining that there is an abnormality, determine a context present when the first health data was present for the first person; and
store an association between the context and the first health data in a computer memory.

9. The computer system of claim 8, wherein execution of the program instructions further configures the computer system to:
identify the context based on a time at which the first health data about the person was measured from the person.

10. The computer system of claim 8, wherein execution of the program instructions further configures the computer system to:
identify the context based on a physical location at which the first health data about the person was measured from the person.

11. The computer system of claim 8, wherein execution of the program instructions further configures the computer system to:
identify the context based on a credit card transaction associated with the first health data about the person.

12. The computer system of claim 12, wherein execution of the program instructions further configures the computer system to:
extract an activity of the first person associated with the first person from the credit card transaction.

13. The computer system of claim 8, wherein execution of the program instructions further configures the computer system to:
identify the context based on a digital payment associated with the first health data about the person.

14. The computer system of claim 8, wherein execution of the program instructions further configures the computer system to:
identify the context based on a social media activity of the first person.

15. A computer program product, comprising:
a computer readable storage medium having programming instructions embodied therewith, the program instructions executable by a computer cause the computer to:
determine a first health data about a first person;
determine whether there is an abnormality of the first health data relative to a baseline data about the person's health;
upon determining that there is an abnormality, determine a context present when the first health data was present for the first person; and
store an association between the context and the first health data in a memory of the computer.

16. The computer program product of claim 15, wherein the program instructions executable by the computer further cause the computer to:
anonymize information about a second person used in determining the context.

17. The computer program product of claim 15, wherein the program instructions executable by the computer further cause the computer to:
determine whether the anomaly occurs repeatedly when the first person is at a physical location.

18. The computer program product of claim 15, wherein the program instructions executable by the computer further cause the computer to:
determine whether the anomaly occurs repeatedly at a particular time of day, week, or month.

19. The computer program product of claim 15, wherein the program instructions executable by the computer further cause the computer to:
store the association between the context and the first health data in an electronic medical record (EMR) of the first person.

20. The computer program product of claim 15, wherein the program instructions executable by the computer further cause the computer to:
determine the baseline data about the person's health from an electronic medical record (EMR) for the person.
